(19) United States
(12) Patent Application Publication
(10) Pub. No.: US 2015/0240098 A1
(43) Pub. Date: Aug. 27, 2015

(54) Color Changing Fabrics

(71) Applicant: Gregory DeMille, Belleville (CA)

(72) Inventor: Gregory DeMille, Belleville (CA)

(21) Appl. No.: 14/629,861

(22) Filed: Feb. 24, 2015

Related U.S. Application Data
(60) Provisional application No. 61/966,472, filed on Feb. 24, 2014.

(51) Int. Cl. C09D 11/50; D06M 23/06

(52) U.S. Cl. CPC C09D 11/50; D06M 23/06

(57) ABSTRACT

A method of making fabrics which allows the user of the fabric to change colour on a controllable, reversible basis, using an activation spray and a different deactivation spray allowing for multiple colour changes and reversals of such colour changes.

### BACKGROUND OF THE INVENTION

1. Field of the Invention

The present invention relates to colour changing fabrics providing for controlled reversible changes of colour on a user controlled basis.

2. Description of Prior Art

The use of colour changing inks to indicate wetness or changes in pH level are well known in the industry. For example, wetness indicator indicating compositions are disclosed in U.S. Pat. No. 7,159,532 issued to Klofta et al.

These colour changing inks are used to detect and confirm changes in pH, changes in wetness levels and are used as indicators.

The colour changes in such wetness or pH indicators are permanent. Once the colour change in made, the item then remains in the changed colour state.

There remains a need for a controllable reversible change in colour which can be easily activated by the user, showing one colour or colours which remain set until an agent is applied to reverse the colour change.

It is the controllable nature of the colour change on a reversible basis which allows for multiple colour changes and reversals activated by the user rather than environmental conditions, which is the problem which needs to be addressed.

### SUMMARY OF THE INVENTION

This invention provides for a method of making user controlled spray activated colour changing fabrics and inks.

A first aspect of the present invention provides for a fabric or substrate which is printed with a permanent ink in a colour or combination of colours on the fabric or substrate. Another ink is applied over the fabric, which ink is capable of colour change based on a change in specific pH range. The colour changing ink is clear, and colourless, within a specific pH range. Where the ink reacts with a solution or medium outside the specific pH range, it changes colour state from a clear, colourless state to a coloured state. Where the ink changes from a clear, colourless state to a coloured state, the second colour is a different colour from the colour of the underlying fabric or substrate. An activating spray is then applied by the user, which activating spray has a pH range outside the range for the clear, colourless state, which activates the colour change in the ink layer. This hides the underlying ink colour and the ink shows the colour which is the colour of the ink after the change in colour state.

The inks are capable of a change in colour state from the coloured state back to the clear, colourless state upon application of a different deactivation spray which has a significantly different pH level than the activation spray and falls within the range of pH for the ink within which it is clear and colourless, reversing the colour change.

A second aspect of the present invention provides for the colour changing ink which is applied over the fabric which changes from one colour state to another colour state and not from a clear, colourless state to a coloured state. The change is activated at a change in pH level when the solution is applied by the activation spray, which solution is above the triggering pH level, and the change from one colour state to the other colour state is initiated. When the different deactivation spray is applied with a pH level below the trigger pH level, the ink changes from its second colour state back to the original colour state.

Changes in colours can be triggered by other activating mechanisms other than the change in pH levels, such as solvents, and also chemical reactions, such as those using nitrates.

It should be noted that every range given throughout the specification will include every narrower range that falls within the broader range as if all such ranges were expressly written herein.

This method allows for many options, including an activating spray allowing a team's jersey to change from home colours to away colours and reverse back using the deactivating spray from away colours to home colours, depending on the event attended.

### BRIEF DESCRIPTION OF THE DRAWINGS

FIG. 1 represents the fabric printed in a permanent colour with various patterns and colours included.

FIG. 2 is the same fabric showing the application of the activation spray to a portion of the fabric.

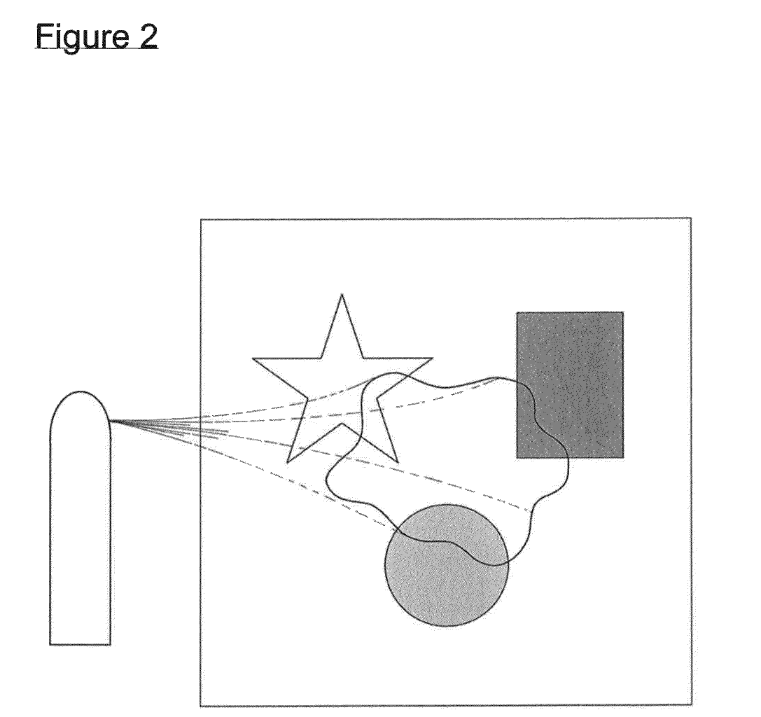

FIG. 3 shows the colour change after the application of the activation spray and the change in colour state activated by the activation spray's PH level being in excess of the range at which the change in colour state occurs in the ink layer.

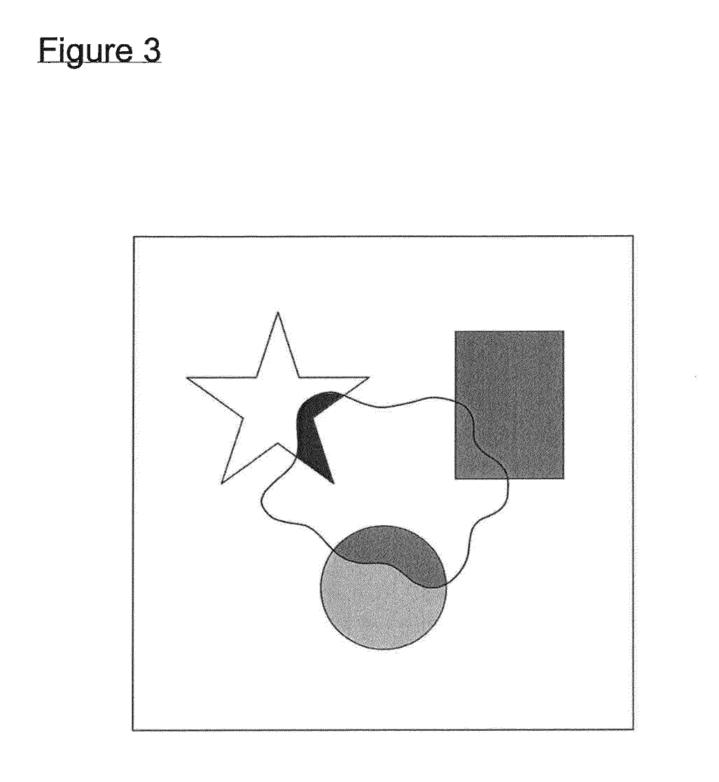

### DESCRIPTION OF THE PREFERRED EMBODIMENT

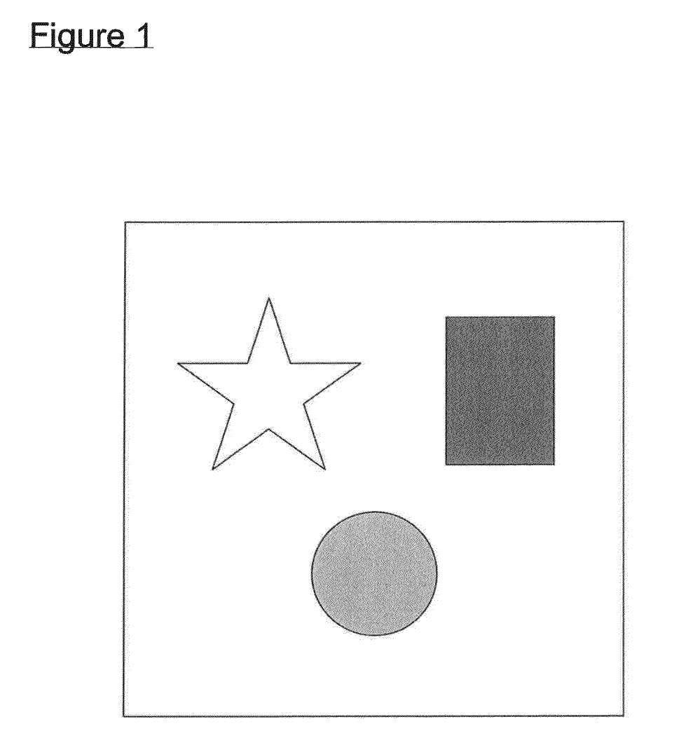

Referring to FIG. 1, a fabric material is dyed or coloured with inks which are permanent in colour in set colour or patterns or a combination of colours or patterns.

Such fabric material may be composed of woven or non-woven fibers, which fibers may include, without limitation, fibers formed from artificial or natural materials or plants.

To this fabric material is applied a halochromatic ink. This halochromatic ink is in a transparent state within the range of pH values, preferably a range which is typical for most external environments.

The halochromatic ink changes to a coloured state from the transparent state when subjected to a change in pH through the application of an activating solution having a pH above a threshold level when a high pH activating solution is applied or below a threshold level when a low pH activating solution is applied.

Such halochromatic inks typically change colour by a change in the conjugation systems of the molecules, or a change in the electron flow.

The halochromatic inks, when a low pH solution is applied to the ink, exhibit protonation, and exhibit de-protonation when a high pH solution is applied to the ink affecting the range of electron flow.

The halochromatic ink formulation is applied to the fabric by dipping, dripping, spray, coating, dying, roll coating, printing or any other suitable technique. The ink is then dried.

The user typically applies a solution, which is a high pH solution with a pH above the threshold pH range which causes a change in colour for the halochromatic ink from a transparent state to a non-transparent state. Such solution is applied by an aerosol spray in the preferred embodiment. This causes a change in the halochromatic ink to a coloured state, hiding the colours of the fabric material which are permanently printed on such fabric material.

This change can be reversed by applying a deactivating solution, typically a low pH solution, if the first activating solution is a high pH solution, which deactivating solution has a pH below the pH threshold at which the change from transparent to non-transparent state occurs in the halochromatic ink, so that the ink changes back to a transparent colour state from a non-transparent colour state. This causes the fabric to exhibit the first colours shown, which were the colours of the underlying fabric material.

By controlling the pH levels to which the fabric is exposed by the user, by applying an activation spray to cause a change to a coloured state, and a deactivation change to cause it to go back to the clear coloured state, this allows the user to control the colour displayed. The pH thresholds are chosen at sufficiently high pH thresholds or sufficiently low pH thresholds, that exposure to typical elements in the environmental, such as rain, does not cause a change in the colour state. As any change can be reversed, so even if a change in colour state is caused by an external application of a fluid or solution, this can be reversed by applying the deactivation spray. The change in colour state can be made and reversed multiple times.

By the application of halochromatic inks to only part of the fabric, the colour change can occur on only part of the fabric material. As well, by application of the activating solution to only part of the fabric, the change can also occur on only part of the fabric to which the activating solution is actually applied.

We claim:

1. A reversibly colour changing fabric comprising:
a fabric material printed in a colour or colours or a combination of colours or patterns in a permanent ink;
a layer of colour changing halochromatic ink, which configured to be in a first transparent state within a pH range and in a second non-transparent state, above a set pH threshold displaying different patterns or colours than the fabric material, and where the ink layer changes from the first transparent state to the second non-transparent state when the pH level exceeds the pH threshold;
to which is applied an activating solution with a pH level which exceeds the pH threshold and is applied in the form of aerosol spray;
to which can be applied subsequent to the application of the activating solution a deactivating solution with a pH level below the pH threshold, which changes the colour state from a non-transparent colour state to a transparent colour state.

2. The fabric and solution of claim 1, where the ink layer changes from the first transparent state to the second non-transparent state when the pH level is less than a set pH threshold and the activating solution has a pH level below the pH threshold and the deactivating solution has a pH level above the pH threshold.

3. The fabric material and solutions of claim 1 wherein the activating and deactivating solutions are applied by a pumped spray.

4. The fabric material and solutions of claim 1 where the activating and deactivating solutions are applied manually by direct contact by means of a brush or other similar applicator.

5. The fabric material and solutions of claim 1, where the first colour state is a non-transparent state and the second colour state is a different non-transparent colour state.

6. The fabric material and solutions of claim 1, where the pH thresholds of the activating solutions and deactivating solutions are different.

7. A colour changing object, comprising:
a substrate printed in a colour or colours or a combination of colours or patterns in a permanent ink
a layer of colour changing halochromatic ink, which configured to be in a first transparent state within a pH range and in a second non-transparent state, above a set pH threshold displaying different patterns or colours than the substrate, and where the ink layer changes from the first transparent state to the second non-transparent state when the pH level exceeds the pH threshold;
to which is applied an activating solution with a pH level which exceeds the pH threshold and is applied in the form of aerosol spray;
to which can be applied subsequent to the application of the activating solution a deactivating solution with a pH level below the pH threshold, which changes the colour state from a non-transparent colour state to a transparent colour state.

8. The fabric and solution of claim 1, where the ink layer changes from the first transparent state to the second non-transparent state when the pH level is less than a set pH threshold and the activating solution has a pH level below the pH threshold and the deactivating solution has a pH level above the pH threshold.

9. The substrate and solutions of claim 1 wherein the activating and deactivating solutions are applied by a pumped spray.

10. The substrate and solutions of claim 1 where the activating and deactivating solutions are applied manually by direct contact by means of a brush or other similar applicator.

11. The substrate and solutions of claim 1, where the first colour state is a non-transparent state and the second colour state is a different non-transparent colour state.

12. The substrate and solutions of claim 1, where the pH thresholds of the activating solutions and deactivating solutions are different.
